(19) United States
(12) Patent Application Publication
(10) Pub. No.: US 2020/0017332 A1
(43) Pub. Date: Jan. 16, 2020

(54) METHOD OF CONTROLLING A STAIRLIFT AND A STAIRLIFT

(71) Applicants: THYSSENKRUPP STAIRLIFTS B.V., Krimpen aan den ljssel (NL); THYSSENKRUPP AG, Essen (DE)

(72) Inventors: Cornelis BOXUM, Delfgauw (NL); Paul KASBERGEN, Capelle aan den IJssel (NL); Albertus BLOKZIJL, Capelle aan den Ijssel (NL)

(73) Assignees: Thyssenkrupp Stairlifts B.V., Krimpen aan den Ijssel (NL); thyssenkrupp AG, Essen (DE)

(21) Appl. No.: 16/490,671

(22) PCT Filed: Mar. 8, 2018
(86) PCT No.: PCT/EP2018/055729

§ 371 Date: Sep. 3, 2019

(30) Foreign Application Priority Data
Mar. 8, 2017 (DE) 10 2017 203 774.1

(51) Int. Cl. B66B 1/30; B66B 9/08

(52) U.S. Cl. CPC B66B 1/30; B66B 9/08; B66B 9/0853

(57) ABSTRACT

A method of controlling a stairlift, the stairlift including a rail, a chair, and a drive assembly having a drive engine for driving the chair along the rail. The chair is attached to the drive assembly and the chair has an armrest, wherein the armrest is pivotably supported at the chair by a hinge. The hinge allows a rotational movement of the armrest, in particular along a vertical axis. The method includes detecting an angular position of the armrest and controlling at least one functionality of the stairlift, in particular a functionality of the drive assembly, as a function of the detected angular position.

WO 2013/129923 A1 discloses a stairlift. The stairlift comprises a chair mounted on a drive assembly. The drive assembly travels along at least one guide rail. A leveling mechanism is provided to hold the chair always in a horizontal orientation, even if the inclination angle of the guide rail is changing.

Typically, stairlifts have a chair which can be folded in order to safe space on the staircase when the stairlift is not in use. In most cases, the armrest can be folded by rotating the armrest partly around a horizontal axis. When unfolding the armrest, the armrest is rotated downwards until it reaches a mechanical stop and the armrest stays in this position due to gravitational forces. To support different sizes of person there are curved armrests for small users and straight armrests for large users. Both types rotate around a horizontal axis.

It is the object of the present invention to develop an improved stairlift, providing improved safety and comfort. The object of the invention is solved by method of controlling a stairlift and a stairlift according to the independent claims; preferred embodiments are subject of the subclaims and the description.

The inventive stairlift comprises a rail, a chair, a drive assembly having a drive engine for driving the chair along the rail, the chair is attached to the drive assembly, the chair having an armrest, wherein the armrest is pivotably supported at the chair by a hinge, which allows a rotational movement of the armrest, in particular along a vertical axis. The inventive method comprises the steps of detecting an angular position of the armrest; the step of controlling at least one functionality of the stairlift, in particular a functionality of the drive assembly, as a function on the detected angular position.

In the inventive stairlift the armrest serves in particular for securing the passenger against dropping out of the chair. This is only possible in certain positions of the armrest. By the inventive detection step it can be checked, whether the armrest is in a position of securing the person. If the armrest is not in appropriate position of securing the person, e.g. the engine may not be driven the swiveling mechanism may be blocked.

In an embodiment the functionality may be a functionality of the drive engine, in particular driving the drive engine or stopping the drive engine or altering a drive speed of the drive assembly along the rail.

In an embodiment the drive assembly comprises a swivel engine for swiveling the chair along a vertical axis. In this embodiment the at least one functionality of the stairlift is a functionality of the swivel engine of the drive assembly, in particular driving the swivel engine or stopping the swivel engine or altering a swivel angle of the chair. Here the knowledge of the armrest position can be used to decide whether the swivel engine is e.g. allowed to swivel the chair or not. Since the armrest may radially protrude in several positions, it may improve the safety, if the chair is being hindered from swiveling.

In an embodiment the step of controlling a functionality of the drive assembly is performed additionally as a function of the position of the chair along the rail. The spatial conditions may vary at different positions along the rail. Thus some restrictions in the functionality can be limited to certain positions.

The inventive stairlift has an angular sensor for detecting the angular position of the armrest.

In particular, the armrest can be pivoted about a vertical axis. This allows that in a radially outward armrest position the armrest can be used for supporting the person getting on or off the chair. However this position of the armrest may be comfortable during entry, the position must be changed due to the above mentioned safety reasons.

In an embodiment the control unit is adapted to control the drive assembly as a function of the angular position detected by the angular sensor. The advantageous and the improvements described with reference to the method are generally applicable to the apparatus claims.

In an embodiment the chair comprises a, in particular a spring loaded, latch mechanism to lock the armrest in a, in particular in-discrete, angular position. A latch sensor is provided for detecting, whether the latch mechanism is in a locked state or an unlocked state. The step of controlling a functionality of the drive assembly can be performed additionally as a function of the result of the checking step. By this functionalities which require safety measurements can be supported by an improved safety standard.

The invention is described in more detail by means of the figures, herein shows.

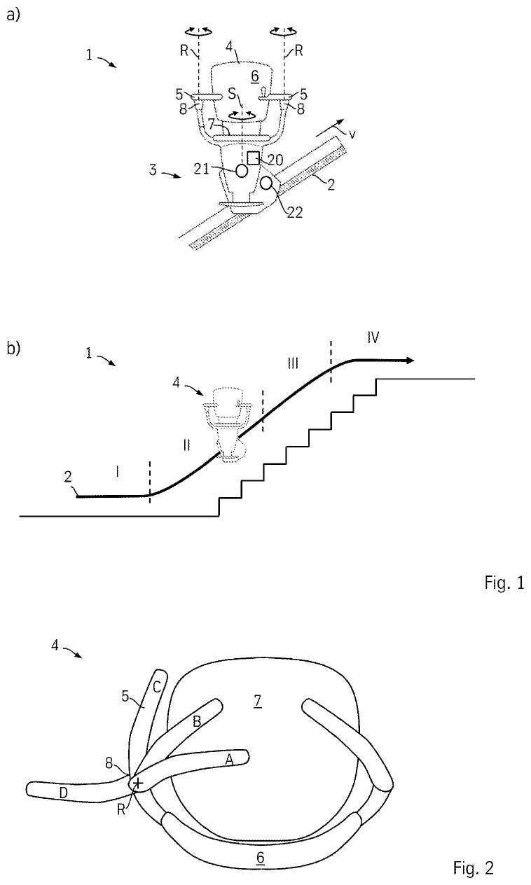

FIG. 1 an inventive stairlift in side view;

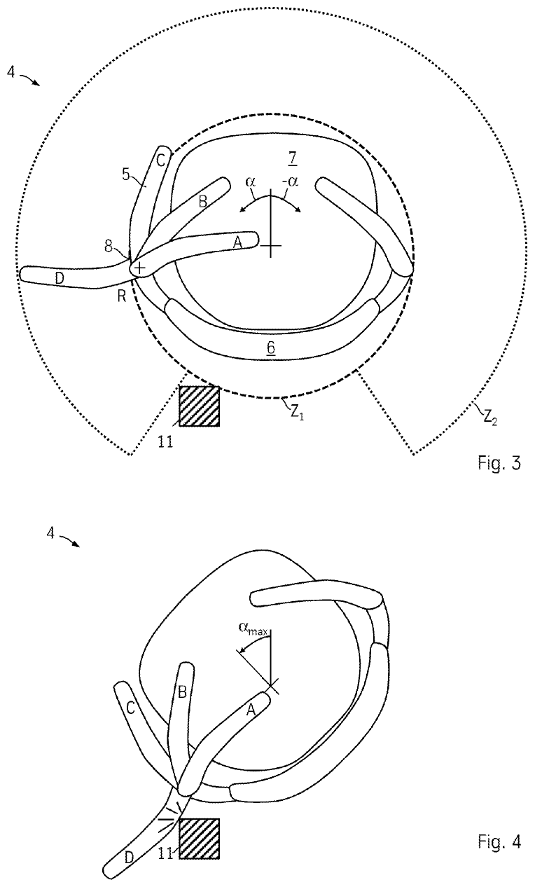

FIG. 2 the chair of the stairlift of FIG. 1 in top view;

FIG. 3 the chair of the stairlift of FIG. 1 in a first swiveling position and an obstacle in top view;

FIG. 4 the chair of the stairlift of FIG. 1 in a second swiveling position and the obstacle in top view;

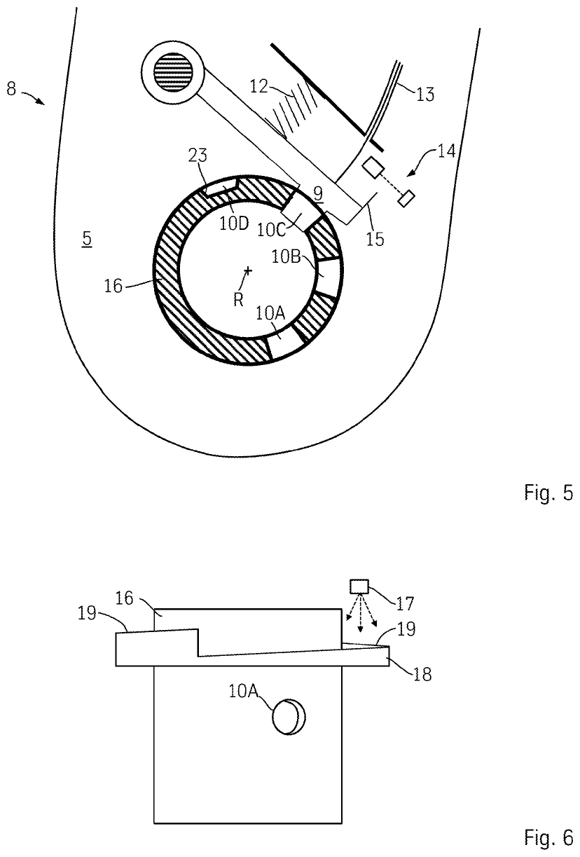

FIG. 5 a hinge area of the armrest of the stairlift of FIG. 1 in top view;

FIG. 6 a part of the hinge area of FIG. 5 in side view;

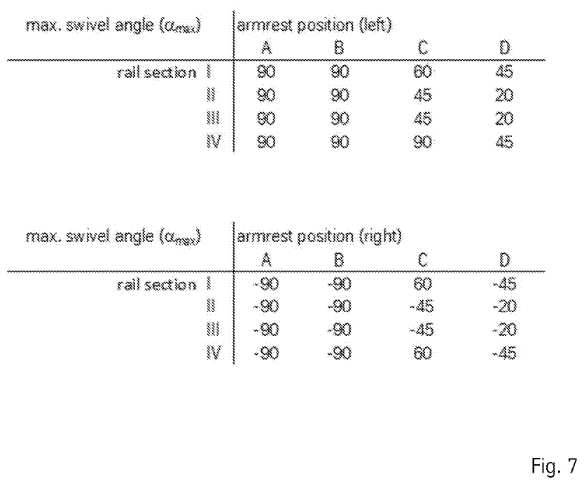

FIG. 7 a table showing allowed conditions referring to the angular position of the armrest and swiveling position of the chair.

FIG. 1 shows an exemplary embodiment of an inventive stairlift 1. The stairlift 1 comprises a rail 2 and a drive assembly 3 with a drive engine 22, which travels along the rail 2. The drive engine 22 drives the drive assembly 3. A chair 4 having a seating 7 and a backrest 6 is mounted to the drive assembly 3. The chair 4 has two armrests 5 mounted by a hinge 8, which allows a pivotal movement of the armrest 5 along a vertical axis R. The stairlift 1 comprises further a swivel engine 21, which is adapted to swivel the chair 4 relative to the drive assembly 3 along a vertical axis S. By swiveling the chair 4, a collision of the chair 4 or the person sitting on the chair with obstacles in the path can be avoided. A control unit 20 is provided for controlling the functions of the stairlift 1.

FIG. 2 shows the left armrest 5 in different angular positions A-D. In position A no person can be accommodated on the chair 4. The position A is for storing the chair 4, when the stairlift 1 is not in use. In this armrest position also the chair 4 can be folded to reduce the storage space.

In position B a small or medium sized person can be accommodated on the chair, in position C a tall sized person can be accommodated. In the position B and C the armrest serves also for securing the person against dropping out of the chair.

In position D, the armrest 5 is opened for allowing a person to enter or leave the chair 4,e.g. from or to a wheelchair. In position D it is not allowed to move the chair. In an embodiment the drive engine 22 may be blocked, when the armrest position A or D is detected. Then it is prevented to move the drive assembly along the rail.

FIG. 3 shows the upper part of the chair 4 in a first angular position α=0°. There are shown two clearance zones Z₁, Z₂. The first zone Z₁ is a small clearance zone, which is kept free from any obstacles 11. It allows that the chair 4 can be swiveled along a swivel angle α of even +/−180° (in both directions), without colliding with an exemplary obstacle 11, when the armrest is in position A or B. However in practice the swivel motion will usually be stopped at α=+/−90°, because a footrest (non-shown) may collide latest at α=+/−90° with the rail 2.

If the armrest 5 is in position C or position D, the armrest 5 may collide at a certain angular position with the obstacle 11 (FIG. 4). Therefore a second clearance zone Z2 is established, which has a larger radial extent, but a reduced angular extent compared to the first clearance zone Z1. Accordingly a maximum angular position αₘₐₓ of e.g. 60° is defined and linked to armrest position C. These maximum angular positions may be defined for each individual stairlift installation and each armrest position, based on the limiting features at the respective individual staircase. Further the maximum angular positions may be defined separately for individual positions of the path of travel. Because at a position of the rail, where are no obstacles, no additional limitation of the swivel angle is necessary. In an embodiment a obstacle clearance zone may be provided around an obstacle. The obstacle clearance zone must not intrude into the first and/or second clearance zones.

FIG. 5 shows the armrest locking mechanism. In the hinge 8 a movable latch 9 is provided which is rotatably supported against a ring shaped latch plate 16. In this example the latch 9 is fixed to the armrest; the latch plate 16 is fixed to the chair 5. The latch plate 16 comprises a number of latch seats 10A-10D, in which the movable latch 9 can protrude. When the movable latch 9 protrudes into one of the latch seats 10, the latch 9 is in a locked state (shown in FIG. 5), otherwise in an unlocked state. A spring 12 biases the movable latch 9 into the locked state. With the help of a bowden cable 13 and a not shown actuating lever a user can bias the movable latch 9 against the spring force of the spring 22 into the unlocked state.

An optocoupler 14 is provided to detect if the movable latch 9 is in a locked or unlocked state. In the unlocked state a vane 15, which is fixed to the latch 9, cuts through a light beam of the optocoupler. The optocoupler cannot detect the current angular position A-D of the armrest 5.

When the movable latch 9 is in an angular position so that it can protrude into latch seat 10A, the armrest 5 is in position A. When the movable latch 9 is in an angular position so that it can protrude into latch seat 10B, the armrest 5 is in position B. When the movable latch 9 is in an angular position so that it can protrude into latch seat 10C, the armrest 5 is in position C. When the movable latch 9 is in an angular position so that it can protrude into latch seat 10D, the armrest 5 is in position D.

The latch seat 10D has a smaller depth than the other latch seat 10A-10C. Further the flanks 23 of this latch seat 10D are more angled with respect to the radial direction, than the flanks of the other latch seats 10A-10C. This enables that, for transferring the latch into the unlocked state out of latch seat 10D, the bowden cable does not need to be pulled. Solely turning the armrest with a certain amount of force may overcome the spring force. The other latch seats are shaped, so that the unlocked state can solely be reached by pulling the bowden cable.

Based on FIG. 6 it is described, how the angular position of the armrest is detected. A light feeler 17 provides a cone shaped light beam or a scattering light. A reflective plate surface 19, mounted on a ring 18 can reflect the light, arriving on the surface 19. Turning the armrest along axis R the ring 18 pivots relative to the feeler 17. The reflective surface 19 has an inclination in circumferential direction. Thus each angular position is characterized by a specific distance between the feeler 17 and the surface 19. The smaller the distance between the feeler 17 and the surface 19, the smaller is the amount of reflective light, arriving at the feeler 17. The larger the distance between the feeler 17 and the surface 19, the smaller is the amount of reflective light, arriving at the feeler 17. The inclination of the surface 19 is shown as a continuous inclination; however a stepwise inclination is also possible, resulting in a smaller angular resolution of the sensor, which is acceptable in this case, because merely an angular resolution of the four positions A-D is requested.

With the help of the optocoupler 14 it is detected, whether or not the latch 9 is locked in any of the predefined angular positions; with the help of the feeler 17 the angular position is determined.

FIG. 7 shows an exemplary table of allowed conditions referring to the maximum allowed swivel angle. This maximum allowed angle is a function of the armrest position and of the rail position. E.g. when the drive assembly is at lower stop position (e.g. section I in FIG. 1b) the chair can be swiveled by +/−90° degree. E.g. when the drive assembly is in a middle rail section II and the left armrest is in position D, the maximum swivel angle is 20°.

In an alternative embodiment the regulations may be more strict. Here if the armrest is in position D the swivel mechanism and the drive mechanism are always blocked. So before swiveling and driving is allowed the armrest must be brought preferably in one of the positions A,B or at least in in position C.

A violation of these conditions leads to a stop of the drive engine 22 and/or a stop of the swivel engine 21. If afterwards the user turns the armrest back and thus establishes an allowed condition, the engines may get a signal to proceed.

### LIST OF REFERENCE SIGNS

1 stairlift

2 rail

3 drive assembly

4 chair

5 armrest

6 backrest

7 seating

8 hinge

9 movable latch

10 latch seat

11 obstacle

12 spring

13 bowdencable

14 latch sensor/optocoupler

15 vane at latch

16 ring shaped latch plate

17 angular sensor/light feeler

18 ring

19 reflective surface

20 control unit

21 swivel engine

22 drive engine

S vertical swivel axis

R vertical armrest axis

Z swivel clearance area

v drive speed of drive assembly

1.-8. (canceled)

9. A method of controlling a stairlift having a rail, a chair, a drive assembly having a drive engine for driving the chair along the rail, the chair attached to the drive assembly, the chair having an armrest, wherein the armrest is pivotably supported at the chair by a hinge, which allows a rotational movement of the armrest along a vertical axis, the method comprising:
detecting an angular position of the armrest; and
controlling a functionality of the stairlift as a function of the detected angular position.

10. The method of claim 9, wherein the functionality is a functionality of the drive assembly.

11. The method of claim 9, wherein the functionality is a functionality of the drive engine.

12. The method of claim 11, wherein the functionality of the drive engine includes driving the drive engine, stopping the drive engine, or altering a drive speed of the drive assembly along the rail.

13. The method of claim 9, wherein the drive assembly comprises a swivel engine configured to swivel the chair along a vertical axis, and the functionality of the stairlift is a functionality of the swivel engine of the drive assembly.

14. The method of claim 13, wherein the functionality of the swivel engine is driving the swivel engine, or stopping the swivel engine, or altering a swivel angle of the chair.

15. The method of claim 9, further comprising:
controlling a functionality of the drive assembly as a function of the position of the chair along the rail.

16. The method of claim 9, wherein said detecting of the angular position of the armrest additionally checks that the armrest is secured by a locking mechanism and said controlling a functionality of the drive assembly is performed additionally as a function of the result of said check.

17. A stairlift, comprising:
a rail,
a drive assembly configured to drive along the rail,
a chair attached to the drive assembly, the chair comprising:
an armrest, wherein the armrest is connected by a hinge, which is configured to allow a rotational movement of the armrest.
a control unit configured to control the drive assembly, and
an angular sensor configured to detect an angular position of the armrest.

18. The stairlift of claim 17, wherein the rotational movement of the armrest is performed along a vertical axis.

19. The stairlift of claim 17, wherein the control unit is configured to control the drive assembly as a function of the angular position detected by the angular sensor.

20. The stairlift of claim 17, wherein the chair comprises a latch mechanism to lock the armrest and a latch sensor is configured to detect whether the latch mechanism is in a locked state or in an unlocked state.

21. The stairlift of claim 20, wherein the latch mechanism is spring loaded.

22. The stairlift of claim 20, wherein the latch mechanism is configured to lock the armrest in discrete, angular positions.
